(19) United States
(12) Patent Application Publication
(10) Pub. No.: US 2007/0151835 A1
(43) Pub. Date: Jul. 5, 2007

(54) Interior fitting for a vehicle and method for the production thereof

(75) Inventors: Michael Rakers, Koln (DE); Olaf Stoschek, Kronach (DE); Tamas Karacsonyi, Wuppertal (DE); Alexander Czinki, Bonn (DE); Benjamin Gunther, Solingen (DE); Holger Carsten, Holland, MI (US); Hasan Kurt, Koln (DE); Hugues Gall, Orgeval (DE); Michael Schmaul, Koln (DE); Christoph Bellenberg, Koln (DE); Arie Van Den Beukel, Koln (DE); Philipp Helmich, Bergisch-Gladbach (DE); Joachim Schulz, Wermelskirchen (DE); Johan Vissers, Etten-Leur (NL)

Correspondence Address: FOLEY & LARDNER LLP, 777 EAST WISCONSIN AVENUE, MILWAUKEE, WI, 53202-5306, US

(73) Assignee: Johnson controls GmbH

(21) Appl. No.: 10/544,262

(22) PCT Filed: Feb. 2, 2004
(86) PCT No.: PCT/EP04/00911

§ 371 Date: Jul. 20, 2006

(30) Foreign Application Priority Data
Feb. 4, 2003 (DE) 103 04 512.0
Sep. 5, 2003 (DE) 103 41 471.1

(51) Int. Cl. H01H 9/00

(52) U.S. Cl. 200/313

(57) ABSTRACT

An interior fitting for a vehicle, particularly for a motor vehicle, comprises a supporting body, which is provided, at least in areas, with a sensor-functional planar structure and with a covering layer that is located on the side facing the interior. Different output signals can be generated by means of the planar structure according to the location of action thereupon. According to the invention, the covering layer is flexibly designed and completely covers the sensor-functional planar structure.

### CROSS-REFERENCE TO RELATED APPLICATIONS

The present invention claims priority as a national stage application of International Patent Application Serial No. PCT/EP2004/000911 filed on Feb. 4, 2004; and German Patent Application Serial No. 10341471.1 filed on Sep. 5, 2003; and German Patent Application Serial No 10304512.0 filed on Feb. 4, 2003, which are hereby incorporated herein by reference in their entirety.

### BACKGROUND

The invention relates to an interior fitting for a vehicle, in particular for a motor vehicle, comprising a support body which is provided, at least in some regions, with a sensor-functional planar structure and with a covering layer on the side facing the interior, it being possible for different output signals to be generated by means of the planar structure as a function of the location of action thereupon. The invention furthermore relates to a method for operating a vehicle with the use of interior fittings of this type and to a method for the production thereof.

Patent specification U.S. Pat. No. 5,864,105 discloses a fitting according to the generic type in the form of a seat for a motor vehicle. The seat is provided with an operating device for a seat adjustment, which has a touch-pad arranged on a side surface, a touch-sensitive sensor field with two-dimensional resolution. The touch-pad is provided in some regions with a covering layer of a hard plastic, in which recesses are arranged in the design of the seat projection. The touch-pad is directly touched through these recesses by the operator's finger and brings about an adjustment of the seat as a function of the zone of action upon it. The contour of the recess is used here both for the visual and the tactile orientation of the operator.

This operating device has the disadvantage that the touch-pad is exposed directly to a considerable mechanical stress and to environmental influences.

Furthermore, patent specification U.S. Pat. No. 5,952,630 describes an armrest for a door lining, in which a plurality of operating elements are used, arranged as force-sensitive sensors within or below the outer decorative layer of the armrest. In this case, each sensor takes on the function of a conventional, mechanical switch or push-button with the soft haptic appearance of the surface of the decorative layer being retained.

Of disadvantage here is the necessity of using in each case at least one dedicated sensor element for each function which is to be controlled, which entails complicated wiring and leads to space problems on account of the area required.

In addition, laid-open specification DE 101 33 896 A1 describes a display which covers an airbag covering and can be used, inter alia, to depict navigation information, it being possible, if appropriate, for the display to be changed by means of a touch operation, in an embodiment as a “touch screen”. In this case, the realization in the form of an image-providing film makes it possible to match it to the contour predetermined by the airbag covering.

Since the main attention here is focused on the quality of the image depiction, a wear-resistant covering layer cannot be used. A further disadvantage is that this solution is very cost-intensive.

### SUMMARY

The invention is based on the object of providing an interior fitting for a vehicle with operating devices which can be designed in a variable manner and, if appropriate, can be operated intuitively. Furthermore, an arrangement of the operating devices on surfaces of the interior fittings that have not been used for this purpose up to now is to be possible.

The object is achieved according to the invention in that, in the case of an interior fitting of the generic type, the covering layer is of flexible design and completely covers the sensor-functional planar structure. Impairments due to environmental influences, soiling or wear can therefore be kept away from the sensor-functional planar structure, while at the same time improving the aesthetic appearance. This improvement, may reside in the uniformity of the appearance. For this purpose, it is advantageous to use, for the formation of the covering layer, the same materials, for example textiles, leather or artificial leather or films, which are used in any case for the production of surfaces for interior fittings - for example roof lining, dashboard support or door linings.

An embodiment of the sensor-functional planar structure as a pressure-sensitive sensor unit is advantageous because, as a result, the operating method as is also used in the case of conventional switches or push-buttons and to which the user is accustomed can be retained. At the same time, during the touching which is inherent to the operating process, the haptic, often soft sensation of the interior fitting is imparted to the operator. In order to emphasize this effect, a compressible intermediate layer can be fitted either between covering layer and sensor-functional planar structure or between sensor-functional planar structure and the support body, there being a further preferred variant, particularly in the first case, according to which this layer additionally contains in punctiform fashion molded pieces of increased stiffness. As a result, the flexibility of the surface of the interior fitting is largely retained in the case of compressive stressing over a large area while an application of force over a small area of the covering layer is passed on primarily via the molded pieces. A compressive stress is therefore applied particularly to those zones of the sensor-functional planar structure which are situated directly under them; there is therefore a concentration function.

Also advantageous is the arrangement of an intermediate layer having a rubber-elastic character, for example of silicone material, in the manner of a keypad mat. In addition to the concentration of the application of force to the regions of the sensor-functional planar structure directly below the key regions of the keypad mat, a haptic feedback about the actuation to the operator can therefore additionally be obtained with the use of the customary, nonlinear .configuration of the restoring force of the key element in relation to the actuating distance.

The depiction of a meaning of an operating panel can be achieved in a simple manner with the assistance of visual means, for example colored contrasting of an operating panel from its surroundings or equipping with symbols or pictograms.

Provision is made here for a number of reasons to design the covering layer which bears means of this type in a manner such that it can be interchanged. First of all, a renewal of the covering layer if it has become worn or dirty can therefore be carried out. It is furthermore thus possible to reconfigure the operating element by, for example, the pictograms or symbols indicating a meaning being changed by exchanging them.

An advantageous embodiment of the invention furthermore arises by the integration of an illuminating device in the interior fitting, as a result of which an identification of functional zones of an operating panel can be assisted or brought about.

A flat variant can preferably be used as the illuminating device in order to avoid restrictions in the construction of the interior fitting, for example an electroluminescent film, an OLED or polyLED. The preferred position of this component arises here from the boundary conditions concerned with design. Given a sufficient degree of transmission of the sensor-functional planar structure and the covering layer, for example in an embodiment in textile material, an arrangement of the light source under these layers is possible, particularly directly under the sensor-functional planar structure.

A further advantageous variant of the visual orientation assistance reside in the incorporation in the light-conducting fibers in a layer which is suitable in terms of its construction for this, for example a textile covering layer. The regions which are to be depicted can therefore be delimited with particularly sharp contours.

Another aid to the visual orientation can be provided in the projection of light patterns onto those regions which are to be identified of the surface on the side facing the interior, with the advantage of improved perceptibility of the meaning, even from unfavorable viewing angles. It may be advantageous, in particular for a vehicle driver, to make possible for him an orientation in the operating process that does not require visual contact with the operating element. Tactile means may be used for this situation.

One preferred variant is the use of a structured molded part which can be provided with recesses in order thereby to delimit a subregion of the operating surface and thus to provide it with a separate meaning.

For example, an ovally shaped ring structure can be realized, the diameter of which lies in the order of magnitude of a human hand, the inner region defining a zone without a fixed allocation of functions and being used for inputting parameters by means of a stroking movement. This stroking movement can be detected via its property as a continuous stringing together of different locations of action of force on the sensor-functional planar structure, from which information about the direction and/or the speed of the stroking movement can be derived. The embodiment furthermore has molded elements which are embedded in the ring structure and, mounted flexibly, when operated pass on the applied force in the direction of the sensor-functional planar structure, corresponding to the actuation of the key element of a keypad mat. With such a device according to the invention, combined operating actions can be carried out, in which, for example, first of all a selection of the function to be operated takes place by pressing a key and then the parameterization of the function, for example an adjusting direction or a displacement path, is determined in more detail by a stroking movement.

A further possibility for clarifying or identifying operating regions with particular preferences with regard to the aesthetic impression resides, with the elasticity of a covering layer being used, in not producing the structures used for the tactile orientation permanently during the production phase but rather by forming them by means of structural bodies which are arranged below the covering layer, for example electrodynamically shape-variable or controllably moveable structural bodies.

Especially for the operation of thermal functions, it may be advantageous to provide the tactile orientation in just such a manner, for example by the use of heating wires or Peltier elements.

According to the invention, an interior fitting for a vehicle is furthermore provided which preferably has an operating panel, the operating panel having a central region and a plurality of peripheral regions. By this means, a simple and intuitive operation of various components of the vehicle is possible via a single operating panel.

The central region of the operating panel is preferably round. This firstly has the advantage that a visually attractive design of the operating panel is possible and, secondly, that furthermore the operation is facilitated. The expert knows that it is, of course, also possible to design the central region of the operating panel differently, for example in an angular, square, rectangular or else oval manner.

Furthermore preferred according to the invention is an embodiment in which the peripheral regions of the operating panel are arranged in the manner of sectors around the central region. This in particular permits an intuitive operating guidance which also makes it possible to easily associate the operations carried out on the operating panel with their effects or consequences, in particular on different vehicle components.

It is furthermore preferred that the peripheral regions of the operating panel completely surround the central region of the operating panel. This makes it possible to design the operating panel to have an even greater aesthetic effect. In addition such a configuration of the operating panel affords the possibility of operating a multiplicity of vehicle components and nevertheless of keeping the expansion of the operating panel comparatively small.

It is furthermore preferred that the interior fitting is assigned a display device, with it being possible for information items to be displayed on the display device as a function of an operating mode. The combination of the interior fitting according to the invention with a display device makes it possible to use the interior fitting virtually universally to control vehicle components. This permits a very greatly increased variability in the operating possibilities and furthermore results in it being possible to save a multiplicity of mechanical components, in particular switches and the like, in the vehicle, which has the effect of enabling the costs of the vehicle to be considerably reduced or of enabling a corresponding increase in comfort to be obtained at the same costs.

It is preferably furthermore provided that different vehicle components can be operated by means of the operating panel as a function of the operating mode. This makes it possible to make the operation of the vehicle components simple and to permit an intuitive operation of the vehicle components because each operating mode is unambiguously assigned a component, so that operating errors can be largely eliminated.

It is furthermore provided that the operating mode can be changed as a function of the actuation of the central region and/or of the peripheral regions of the operating panel, preferably as a function of the actuation of the peripheral regions of the operating panel. This makes it possible according to the invention to assign an unambiguous assignment of the operating mode, i.e. preferably of the vehicle component to be operated, for the actuation of parts of the operating panel. The operator's guidance for the operating panel is particularly intuitive and simple if (solely) the peripheral regions of the operating panel are used for the definition of the operating mode.

It is furthermore preferred that a different operating mode is assigned the operation of a different vehicle component, in particular the air-conditioning control, the ventilation, a car radio, a navigation device, a car telephone, an audio configuration system, a fuel information system and/or a mobility information system. It is thereby possible in an advantageous manner to assign just one vehicle component or a group of vehicle components which can usually be operated together to just one operating mode, which further simplifies the operation of the operating panel and also renders it accessible for less skilled users. In this case, a mobility information system is to be understood as meaning a plurality of subsystems required for the mobility of the vehicle, for example the battery capacity or the functioning of the power supply in the vehicle, for example the oil pressure and/or the oil temperature or else the tire pressure or the state of the tires.

It is furthermore preferred that, when an operating mode is set, the operation of the vehicle component assigned to the set operating mode takes place as a function of the actuation of the central region and/or of the peripheral regions of the operating panel, preferably as a function of the actuation of the central region of the operating panel. This makes it possible according to the invention for the operation of the assigned vehicle components to take place in a simple and intuitive manner. In particular if an operation of a vehicle mode component which is firmly defined by the set operating mode is carried out exclusively by the actuation of the central region of the operating panel, a clear and easily comprehensively structuring of the operation of the vehicle components is produced to the effect that it is always the central region of the operating panel that is used for operating the set vehicle component.

It is furthermore preferable that the actuation of a central region enables a list selection, which can be displayed on the display device, of functions and/or information items which can be displayed to be carried out. As a result, it is possible, for example for the case of controlling the fuel information system, to carry out one of various functions by means of list selection. For example, one of the functions displayed on the display device as a list relates to the distance which can probably still be covered by the contents of the fuel tank or the average fuel consumption or the fuel consumption at a particular instant or similar information items. Such functions or information items can be realized and displayed by actuation of the central region of the operating panel, for example by means of a double click.

Furthermore, provision is preferably made for the actuation of the central region to enable a map excerpt, which can be displayed on the display device, to be displaced by a directional actuation and to be changed in size (zoomed in/out) by a rotary movement, the map excerpt being in particular the single map excerpt displayed on the display device. It is thereby possible, in a particularly simple, intuitive and rapid manner, to arrive at the desired map excerpt which is to be displayed for a user on the display device. The map excerpt which is displayed and which can be displaced is preferably the single map excerpt displayed, so that no parts of the display device are “wasted” by the display of further map excerpts which are not of interest to a user.

Provision is preferably furthermore made for the actuation of the central region to enable a configuration, which can be displayed on the display device, of the audio configuration system to be changed. This makes it possible to set or change the audio configuration of the vehicle in a simple manner, with a simple and intuitive and, above all, rapid changing or setting of the configuration being possible by the operating panel being coupled to the display device.

### BRIEF DESCRIPTION OF THE FIGURES

The figures illustrate schematically different exemplary embodiments of the invention by way of example.

FIG. 1 shows a longitudinal section through a first embodiment of the interior fitting according to the invention.

FIG. 2 shows a longitudinal section through a second embodiment of the interior fitting according to the invention.

FIG. 3 shows a longitudinal section through a third embodiment of the interior fitting according to the invention.

FIG. 4 shows a longitudinal section through a fourth embodiment of the interior fitting according to the invention.

FIGS. 5a and 5b show a perspective illustration and a longitudinal section through a fifth embodiment of the interior fitting according to the invention.

FIG. 6 shows the interior of a motor vehicle with interior fittings according to the invention.

FIGS. 7 to 13 show a detail of the interior fitting according to the invention with various illustrations of a display device.

### DESCRIPTION OF THE PREFERRED AND EXEMPLARY EMBODIMENTS

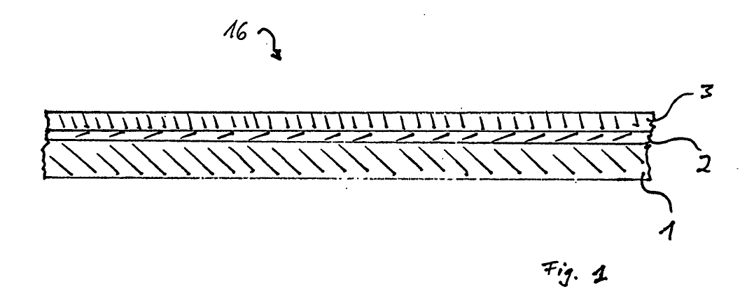

FIG. 1 illustrates a longitudinal section through a first embodiment of an interior fitting 16 according to the invention with a support body 1 and a sensor-functional planar structure 2, the latter being connected to the support body by adhesive bonding, and a covering layer 3 which is likewise connected to the sensor-functional planar structure by adhesive bonding.

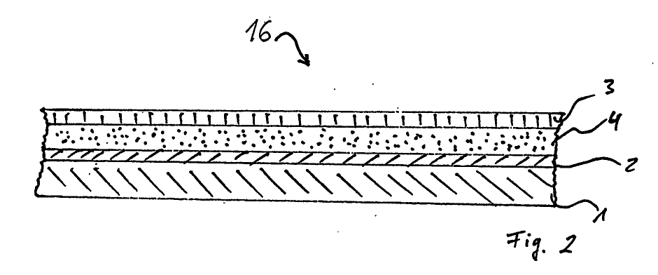

FIG. 2 shows a longitudinal section through a second embodiment of a fitting 16 according to the invention, in which a compressible intermediate layer 4 is additionally arranged below the covering layer 3 and above the sensor-functional planar element 2.

FIG. 3 shows a longitudinal section through a third embodiment of a fitting 16 according to the invention, in which the compressible intermediate layer 4 is arranged below the sensor-functional planar element 2 and above the support body 1.

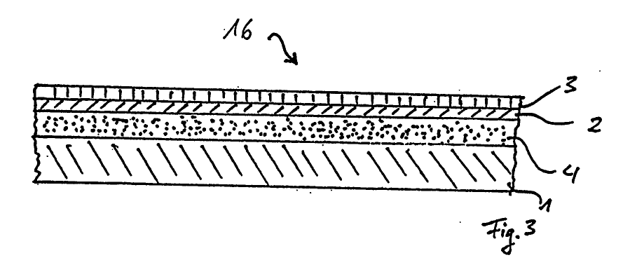

FIG. 4 shows a longitudinal section through a fourth embodiment of the fitting 16 according to the invention with a support body 1, the sensor-functional planar structure 2 arranged above it and a covering layer 3 arranged on the side facing the interior space, with a compressible intermediate layer 4 likewise being arranged between the covering layer 3 and the sensor-functional planar structure 2. Since this force which is exerted in a punctiform manner on the covering layer may possibly be distributed in an undesirable manner over the full area of the sensor-functional planar structure 2, a locally force-transmitting molded piece 5 of a semi-stiff material, for example of silicone, is embedded in the compressible intermediate layer. An insert 6 which comprises a spring.7 in conjunction with a pressure plate 8 has a similar effect. Furthermore, recesses 9 in the compressible intermediate layer 4, which recesses face the sensor-functional planar structure 2, counteract a “smoothing out” of the pressure exerted on the covering layer, with that surface 10 of the compressible intermediate layer 4 which can be brought into contact with the sensor-functional planar structure 2 upon deformation being provided with projections 11.

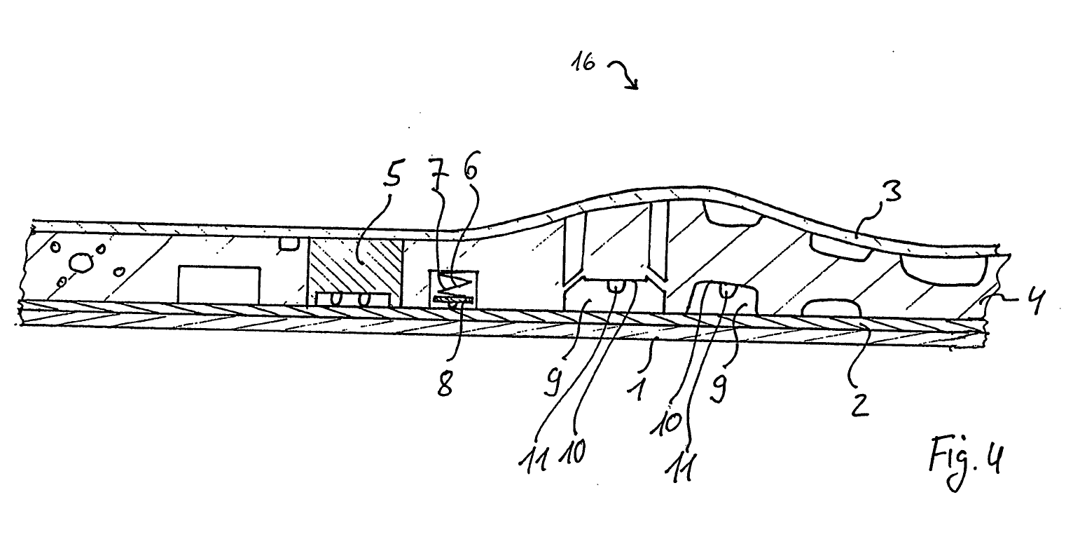

In an embodiment of the fitting 16 according to the invention that is illustrated in FIG. 5, a three-dimensional molded part 12 is arranged on the covering layer 3 covering the sensor-functional planar structure 2, which molded part firstly permits direct access to the covering layer 3 in the region of a recess 13 and secondly has a multiplicity of cutouts 14 in which keys 15 which act on the covering layer 3 and can be actuated by the vehicle occupant are arranged. The cutouts 14 with the keys 15 are arranged here centrically around the circular recess 13.

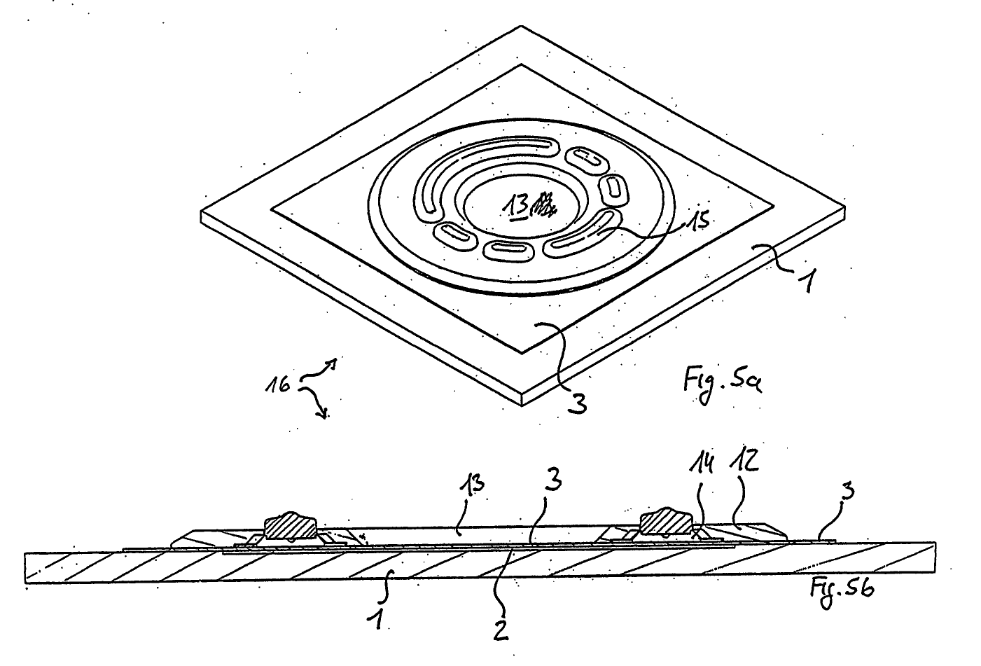

FIG. 6 shows the interior of a motor vehicle with interior fittings 16 configured according to the invention, 16.1 representing a central console, 16.2 a cockpit, 16.3 a door lining and 16.4 the hub surface of a steering wheel.

Arranged on the central console 16.1 is a fitting part 16 which is similar to the fifth embodiment (according to FIG. 5) and has an operating panel 17 via which, for example, a navigation system can be controlled. On that surface of the cockpit 16.2 which is on the side facing the interior, an operating panel 19 can be fitted above the otherwise scarcely useable airbag cover 18, by means of which operating panel the interior illumination for the passenger or his/her individual air-conditioning control can be set. On the door lining 16.3 there is an operating panel 20 for the longitudinal or height adjustment of the driver's seat 21 by electric motor. Also arranged in the hub surface 16.4 is an operating panel 21 for setting the cruise control and an operating panel 22 for actuating the direction indicator.

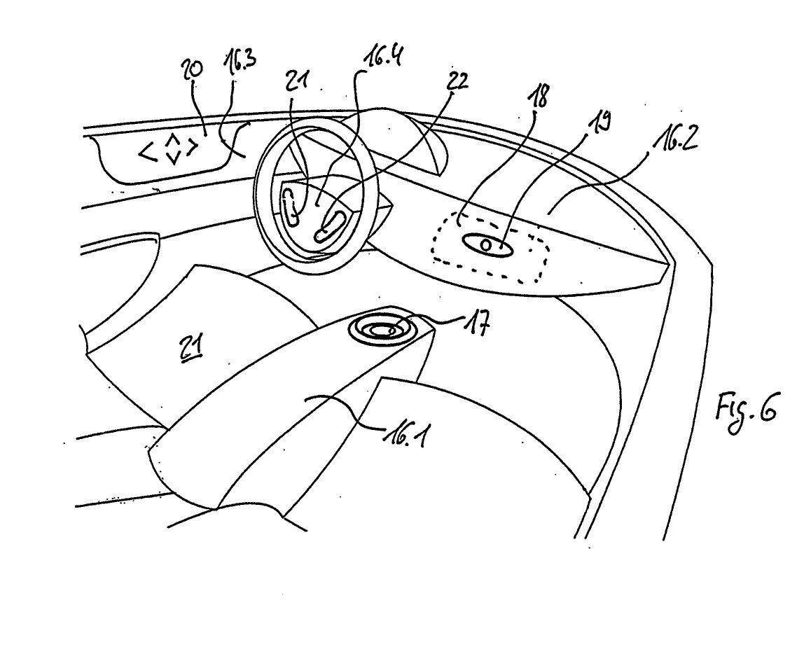

FIG. 7 illustrates a detail of the interior fitting 16 according to the invention with an operating panel 160. The operating panel 160 has a central region 161 and a plurality of peripheral regions, with only a first peripheral region 162, a second peripheral region 163 and a third peripheral region 164 being denoted in FIG. 7. FIG. 7 furthermore illustrates an operating instrument 150 of a user (not illustrated), it being possible for the operating instrument 150 to be, in particular, the hand or a finger of the user. The operating instrument 150, which may also be designed, for example, as a pin, touches the operating panel 160 at a location of action identified by the reference number 151 and an arrow. The upper part of FIG. 7 furthermore illustrates a display device 30 which, divided into regions, has a comparable arrangement for the regions of the operating panel 160. Again, on the display unit 30 or on the display device 30, a central display region is separated from a plurality of peripheral display regions 32. In the peripheral display regions 32, images or pictograms are illustrated on the display device 30 indicating the operating component or vehicle component which corresponds by an actuation of that region 161, 162, 163, 164 of the operating panel 160 which corresponds (i.e. is correspondingly arranged) to the display region 31, 32. In the upper part of FIG. 7, there are arranged or displayed on the display device 30, for example beginning at the top and continuing in the clockwise direction, setting functions for a car radio, setting functions for an air-conditioning control or ventilation of the vehicle, setting functions for operating a car telephone, setting functions for operating a fuel information system, setting functions for operating a mobility information system and setting functions for operating a navigation system. For example, the first peripheral region 162 of the operating panel 160 is assigned to the operation of the car telephone and the second peripheral region 163 of the operating panel 160 is assigned to the air-conditioning control or the ventilation of the vehicle. The third peripheral region 164 of the operating panel 160 is assigned to the operation or the display of information items of the fuel information system. Operation of this third peripheral region of the operating panel 160 causes the appearance, as illustrated in FIG. 8, on the display device 30 in the central display region 31 of a list of functions which can be carried out and which are used to control or operate the fuel information system. For example, a list with various entries, for example for distance traveled and for further information items, is displayed in the central display region 31. Otherwise, the illustrations of FIG. 7 and FIG. 8 entirely correspond, with, in FIG. 8, in contrast to FIG. 7, a selection of the different information items of the fuel information system that are displayed on the display device 30 to be possible by actuation of the central region 161 of the operating panel 160, i.e. by a location of action 151 on the central region 161 of the operating panel 160.

In the operating panel 160 of the interior fitting 16, provision is made for the regions 161 to 164 to differ or to be able to be differentiated discernibly for a user by the fact that the visible side, i.e. the surface of the operating panel 160, is structured corresponding to the different regions 161 to 164. According to the invention, the structuring of the surface is, in particular, discernible to a user in a tactile manner. It is clear that the operation of the central region 161 of the operating panel 160 differs depending on the group of functions selected by one of the peripheral regions 162 to 164 of the operating panel. In this case, the preselection and selection of a certain vehicle component to be operated define the operation of the operating panel 160 in a certain operating mode assigned to this component or to this region of the operating panel 160. The functionality of the central region 161, therefore depends on the preselection of the vehicle component to be operated or of the operating mode by one of the peripheral regions 162 to 164 of the operating part 160, with it furthermore being preferably possible for the functionality of the central region 161 to be freely programmed. In this connection, it is possible, during the programming, for various movements for example of a finger 151 of a user on the operating panel 160, to be recognized, such as, for example, stroking, touching by means of a fingertip, rotating in a circulating manner, pressing heavily or lightly, double clicking and more other movements. Of course, the free programmability is also still possible after purchasing the vehicle, so that, for example, new features of the installed programming can be realized during the service life of the vehicle. The operating panel 160 is preferably integrated in the surface of the interior fitting 16, so that injuries, for example in accident situations, are largely avoided. Furthermore, according to the invention the operating panel 160 can be largely integrated in the surface of the interior fitting 16, so that a visually attractive and not overburdened or overladened atmosphere or appearance of the area around the interior fitting 16 is possible.

These comments apply to all of the operating panels described in conjunction with the present invention, in particular to all of the operating panels 160 described in FIGS. 7 to 13, and so only the differences will be discussed below.

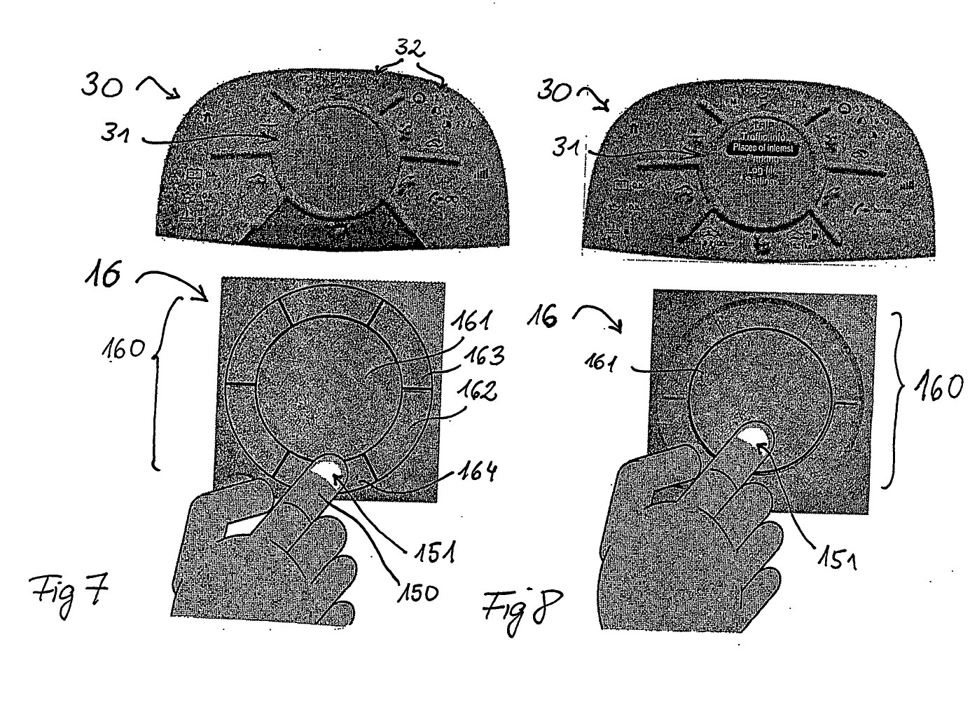

FIG. 9 illustrates a display device 30 and a detail of a display device 30 for the operation of a navigation system. An excerpt of a map is illustrated in the central display region 31.

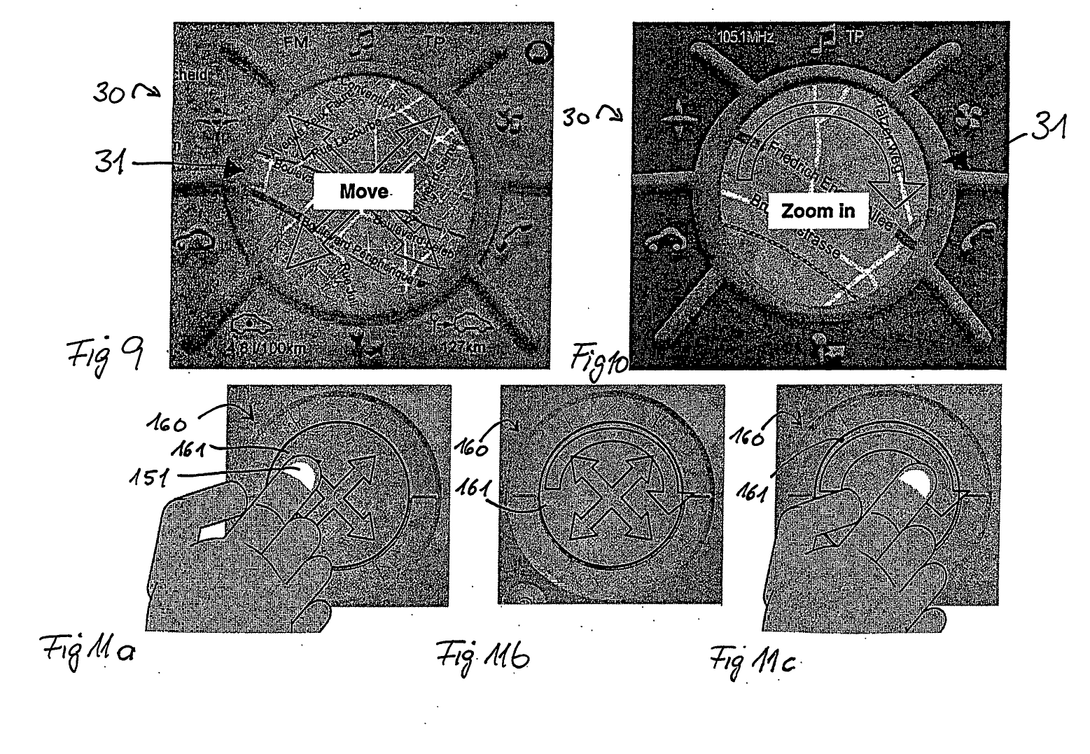

FIG. 10 likewise illustrates a display device 30 with a map excerpt in the central display region 31, but with the map excerpt being enlarged in comparison to the illustration in FIG. 9, i.e. more details of a (geographical) map region, but which is then smaller, being illustrated.

The operation of such an operating panel 160 which is set up for operation in the operating mode to operate a navigation system is illustrated in figures 11a, 11b and 11c. The central region 161 of the operating panel 160 corresponds to or represents the visible map excerpt or in general the visible graphics in the central display region 31. By touching the central region 161 of the operating panel 160, a user can manipulate the visible map excerpt to the effect that he can displace it in all directions and furthermore can also change its size, i.e. “zoom”. A change of the map excerpt both with regard to a movement and with regard to a change in size can be carried out directly and simultaneously. In this connection, a movement of the map excerpt corresponds to a movement of a finger 151 of a user on the central region 161 of the operating panel 160. A circular movement on the central region 161 of the operating panel causes a change in size of the illustrated map excerpt in the central display region 31. It is therefore not necessary to change, for example, a menu or the like in order to carry out the one or other task. The change in the illustration of the map excerpt in the central display region 31 corresponds in this case to the location of action 151 on the central region 161 of the operating panel. This means that if a user touches the central region 161 to the right of the center, the map excerpt will move to the right. If a user touches it at the bottom on the right, the map excerpt will move downward to the right. This results in a direct ability to influence both the map excerpt and also the enlargement factor of the map excerpt. Furthermore, movements on the central region 161 of the operating panel 160 and on the visible part of the graphics or of the map excerpt are coordinated. This enables a selection or display of a desired map excerpt to be undertaken particularly rapidly and particularly simply. It is therefore not necessary according to the invention to carry out a plurality of movement and enlargement steps in order finally to get to the desired map excerpt or to the display of the desired map excerpt; on the contrary, it is possible, by means of simple movements on the central part 161 of the operating panel 160, to select the map excerpt. This produces a particularly intuitive operator's guidance, since the fingers on the central region 161 of the operating panel correspond directly with the size or the position of the map excerpt illustrated. FIG. 11a illustrates a directional actuation of the operating panel 160 by means of arrows (not denoted by means of a reference number) on the central region 161 of the operating panel 160, and figure 11c illustrates a rotary actuation of the central region 161 of the operating panel 160 by means of an arrow (likewise not denoted by means of a reference number) on the central region 161 of the operating panel 160. FIG. 11b illustrates a combination of a directional actuation with a rotary actuation.

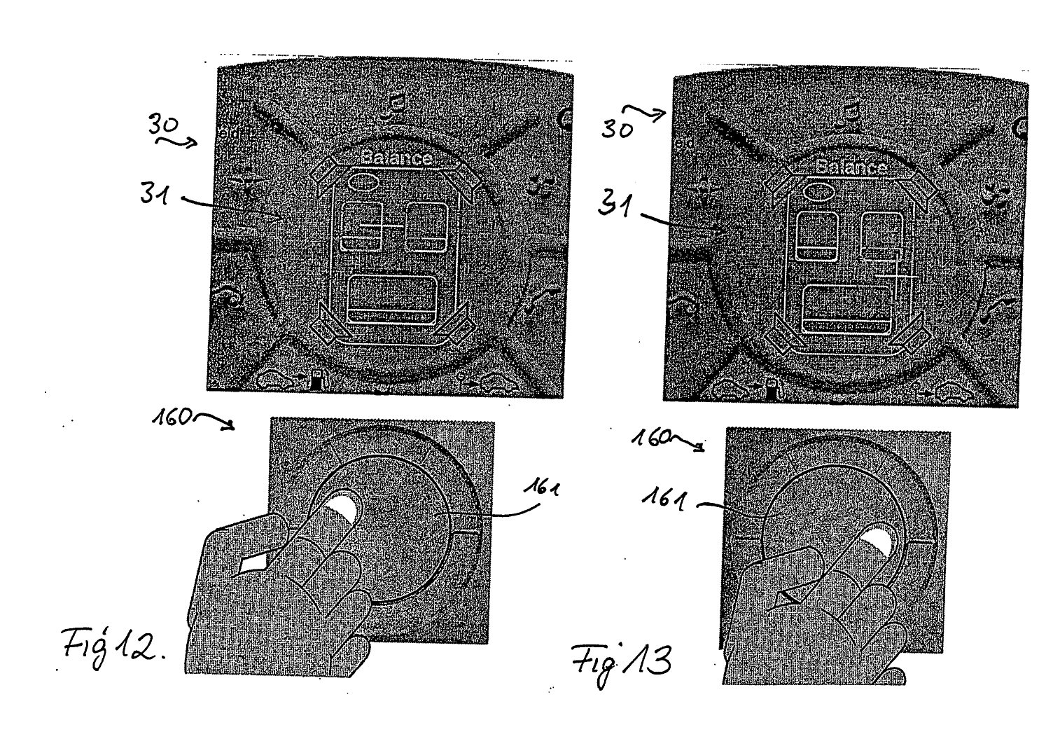

FIGS. 12 and 13 each illustrate an operating panel 160 in the lower part of the figure and a display device 30 in the upper part of the figure, with FIGS. 12 and 13 referring to the operating mode for setting and for operating an audio configuration system. For the situation illustrated in FIGS. 12 and 13, the interior fitting 16 (not denoted in each case) serves, by means of a pressure-sensitive operating panel 160, to simultaneously set the balance and the fader of an audio configuration system of the vehicle. In this case, a location on the central region 161 of the operating panel 160 corresponds to the location in the vehicle or in the interior of the vehicle at which a sound produced by the audio system of the vehicle is heard particularly well. To change or set the audio configuration system, the invention makes provision to touch the central region 161 of the operating panel 160 at a location which corresponds to the desired location of the particularly good audio transmission or audio functionality in the vehicle, with the entire vehicle being at least schematically depicted in the central display region 31 and with the audio configuration being defined by a location of the central region 161 of the operating panel 160 that corresponds to the desired transmission point being pressed. This means that, for example, a user touches the operating panel 160 to the right of the center of the central region 161, as a result of which the location of the audible audio source is likewise moved to the right in the interior of the vehicle. If a user touches the central region 161 of the operating panel 160 at the bottom on the right, this corresponds to a movement diagonally downward to the right of the location of the audible audio source. By this means, it is advantageously possible according to the invention to set both the fader and the balance of the vehicle-internal audio system at the same time and therefore to operate the audio configuration system in a particularly convenient manner. An operating concept of this type can be used universally, for example also in a domestic sphere, in an office sphere, in the area around a truck or in any other vehicle.

According to the invention, it is therefore possible, in a very much more rapid and simpler manner, to bring about an optimum configuration of the audio system of the vehicle (or other space), which was conventionally possible only by repeated and awkward individual adjustments both of the balance and of the fader. According to the invention, it is therefore possible to bring about the optimum audio configuration of the vehicle in a particularly intuitive and rapid manner. It is thereby also possible that the “fader” and “balance” functions, which are actually different acoustically, can be identified by the user as being adjustable and are recognized as being essential for the wellbeing in an acoustic entertainment in the vehicle or in other spaces.

### List of Reference Numbers

1 Support body
2 Sensor-functional planar structure
3 Covering layer
4 Compressible intermediate layer
5 Molded piece
6 Inset
7 Spring
8 Pressure plate
9 Recesses
10 Surface
11 Projections
12 Three-dimensional molded part
13 Recess
14 Cutouts
15 Keys
16 Interior fitting
16.1 Central console
16.2 Cockpit
16.3 Door lining
16.4 Hub surface of a steering wheel
17, 19, 20, 22 Operating panel
18 Airbag cover
21 Driver's seat
30 Display device
31 Central display region
32 Peripheral display regions
150 Operating instrument
151 Location of action
160 Operating panel
161 Central region
162 First peripheral region
163 Second peripheral region
164 Third peripheral region

1-40. (canceled)

41. An interior fitting for a vehicle comprising:
a support body,
a sensor-functional structure coupled to the support body; and
a covering layer coupled to the support body on a side facing the vehicle interior;
wherein different output signals may be generated by the sensor-functional structure as a function of the location of action thereupon;
wherein the covering layer is of flexible design and completely covers the sensor-functional structure.

42. The interior fitting of claim 1 wherein the sensor-functional structure is a pressure-sensitive sensor.

43. The interior fitting of claim 1 wherein the covering layer comprises one of a textile, a woven fabric, a leather, an artificial leather, or a film.

44. The interior fitting of claim 1 wherein the covering layer is arranged directly on the sensor-functional structure.

45. The interior fitting of claim 1 further comprising at least one compressible intermediate layer arranged between the covering layer and the sensor-functional structure.

46. The interior fitting of claim 1 further comprising at least one compressible intermediate layer is arranged between the support body and the sensor-functional structure.

47. The interior fitting of claim 46 wherein the compressible intermediate layer comprises a foam.

48. The interior fitting of claim 46 wherein force-transmitting molded pieces of a stiff or semi-stiff material are arranged in the compressible intermediate layer.

49. The interior fitting of claim 41 further comprising a visual orientation located on a side facing the interior.

50. The interior fitting of claim 49 wherein an illuminating device is arranged below the covering layer.

51. The interior fitting of claim 50 wherein the illuminating device is arranged between the support body and the covering layer.

52. The interior fitting of claim 51 wherein the illuminating device comprises one of an electroluminescent film, an OLED, or a polyLED.

53. The interior fitting of claim 49 wherein the visual orientation comprises images projected onto the covering layer.

54. The interior fitting of claim 49 wherein the visual orientation comprises optical waveguides arranged in the covering layer and/or in the sensor-functional structure.

55. The interior fitting of claim 41 further comprising a tactile orientation.

56. The interior fitting of claim 55 wherein the tactile orientation comprises a structured molded component of a stiff or semi-stiff material.

57. The interior fitting of claim 56 wherein the structured molded component comprises recesses.

58. The interior fitting of claim 55 wherein the tactile orientation comprises changeable structures so that operation of the sensor-functional structure can be reconfigured.

59. The interior fitting of claim 55 wherein the tactile orientation comprises regions of different surface temperature.

60. The interior fitting of claim 41 further comprising an operating panel having a central region and a plurality of peripheral regions.

61. The interior fitting of claim 60 wherein the peripheral regions of the operating panel are arranged in sectors around the central region.

62. The interior fitting of claim 61 wherein the central region of the operating panel is round.

63. The interior fitting of claim 62 wherein the peripheral regions of the operating panel completely surround the central region of the operating panel.

64. The interior fitting of claim 60 further comprising a display device on which information can be displayed as a function of an operating mode.

65. The interior fitting of claim 64 wherein different vehicle components can be operated by the operating panel as a function of the operating mode.

66. The interior fitting of claim 41 wherein a continuous adjustment of a vehicle component which is to be operated is associated with the direction (x direction, y direction) and/or speed (dx/dt, dy/dt) of a continuous displacement of the location of action on the sensor-functional structure.

67. The interior fitting of claim 41 wherein an adjustment of a vehicle component which is to be operated is associated with the pressure which is exerted on the sensor-functional planar structure.

68. The interior fitting of claim 67 wherein a continuous adjustment of a vehicle component which is to be operated is associated with a continuous change of pressure.

69. A method for the production of an interior fitting comprising:
providing a support body;
laminating a sensor-functional structure onto the support body; and
laminating a covering layer onto the sensor-functional planar structure.

70. The method of claim 69 further comprising the step of forming a sandwich from the covering layer and the sensor-functional structure and laminating the sandwich onto the support body.

71. The method of claim 70 further comprising laminating the sandwich onto the support body.

72. The method of claim 70 wherein the covering layer is of gas-permeable design and the sensor-functional planar structure is positioned in relation thereto by application of a negative pressure on that surface of the covering layer that is on the side facing the interior.

73. The method of claim 69 further comprising providing a composite by placing the covering layer and the sensor-functional structure into a die, filling an interior space between the covering layer and the sensor-functional structure with foam, and laminating the composite produced in this manner onto the support body.

74. The method of claim 73 wherein the covering layer is plastically preformed before being placed into the die.

75. An interior fitting for a vehicle comprising:
a support body,
a touch-sensor coupled to the support body; and
a covering layer coupled to the support body on a side facing the vehicle interior and having an operating panel having a central region and a plurality of peripheral regions;
wherein different output signals may be generated by the touch-sensor as a function of the location of action thereupon;
wherein the covering layer is of flexible design and completely covers the touch-sensor.

76. The interior fitting of claim 75 wherein the peripheral regions of the operating panel are arranged in sectors around the central region.

77. The interior fitting of claim 76 wherein the central region of the operating panel is round.

78. The interior fitting of claim 77 wherein the peripheral regions of the operating panel completely surround the central region of the operating panel.

79. The interior fitting of claim 75 further comprising a display device on which information can be displayed as a function of an operating mode.

80. The interior fitting of claim 79 wherein different vehicle components can be operated by the operating panel as a function of the operating mode.

81. The interior fitting of claim 80 wherein the operating mode can be changed as a function of the actuation of the central region and/or of the peripheral regions of the operating panel.

82. The interior fitting of claim 81 wherein operating modes are assigned the operation of vehicle components, wherein the components comprise one of air-conditioning, ventilation, car radio, navigation device, telephone, audio configuration system, fuel information system, and/or mobility information system.

83. The interior fitting of claim 82 wherein when the operating mode is set, the operation of the vehicle component assigned to the set operating mode takes place as a function of the actuation of the central region and/or of the peripheral regions of the operating panel.

84. The interior fitting of claim 79 wherein actuation of the central region displays a list on the display device of functions that can be carried out and/or of information that can be displayed.

85. The interior fitting of claim 84 wherein actuation of the central region enables a map excerpt to be displayed on the display device, to be displaced by a directional actuation, and to be changed in size by a rotary actuation.

86. The interior fitting of claim 85 wherein actuation of the central region enables a configuration of the audio configuration system to be changed.
